(19) United States
(12) Patent Application Publication
(10) Pub. No.: US 2021/0216071 A1
(43) Pub. Date: Jul. 15, 2021

(54) Mapping and Control System for an Aerial Vehicle

(71) Applicant: Emesent IP Pty Ltd., Pullenvale, Queensland (AU)

(72) Inventors: Farid Kendoul, Pullenvale, Queensland (AU); Stefan Hrabar, Pullenvale, Queensland (AU)

(73) Assignee: Emesent IP Pty Ltd., Pullenvale, Queensland (AU)

(21) Appl. No.: 17/058,849

(22) PCT Filed: May 24, 2019
(86) PCT No.: PCT/AU2019/050512

§ 371 Date: Nov. 25, 2020

(30) Foreign Application Priority Data
May 25, 2018 (AU) 2018901838

(51) Int. Cl. G05D 1/00; B64C 39/02; G05D 1/10

(52) U.S. Cl. CPC G05D 1/0094; G05D 1/0088; B64C 2201/146; G05D 1/101; B64C 2201/141; B64C 39/024

(57) ABSTRACT

A mapping and control system for an aerial vehicle, the system including a payload attachable to the aerial vehicle, the payload including: a range sensor that generates range data indicative of a range to an environment; a memory for storing flight plan data indicative of a desired flight plan; a communications interface; and one or more processing devices that: use the range data to generate pose data indicative of position and orientation of the payload relative to the environment; use the pose data and the flight plan data to identify manoeuvres; generate control instructions; and transfer the control instructions to a vehicle control system of the aerial vehicle via the communications interface, to cause the aerial vehicle to implement the manoeuvres and thereby fly autonomously in accordance with the desired flight plan, wherein the range data is further for use in generating a map of the environment.

### BACKGROUND OF THE INVENTION

The present invention relates to a mapping and control system for an aerial vehicle, and in particular to a mapping and control system that can be attached to an aerial vehicle, such as an unmanned or unpiloted aerial vehicle.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Unmanned aerial vehicles, often referred to as drones, are being used and adopted for industrial applications at an increasing rate and there is need and demand for more automation to increase the safety and efficiency of data collection. Furthermore, there is demand for additional functionality beyond standard cameras and images. For example, 3D Lidar (Light Detection and Ranging) data can be used to provide mapping functionality, which can benefit many industrial applications. Most Lidar systems utilise GPS and high-grade IMUs and as a result the systems tend to be expensive and are only able to operate in environments where GPS is available, meaning these cannot be used in GPS-denied environments such as indoors and underground.

Whilst some systems have been described that use SLAM-based Lidar, all of these are “passive” in the sense that they just collect data and use this for subsequent mapping, with drone guidance and flying being controlled by existing drone autopilots.

Additionally, in traditional approaches, the payload is separate to the components and systems of the drone, both in terms of hardware and software, meaning for mapping applications the payload is using its sensors for mission data collection, and the autopilot is using different sensors for navigation and flight automation.

### Summary of the Present Invention

In one broad form an aspect of the present invention seeks to provide a mapping and control system for an aerial vehicle, the system including a payload attachable to the aerial vehicle, the payload including: a range sensor that generates range data indicative of a range to an environment; a memory for storing flight plan data indicative of a desired flight plan; a communications interface; and, one or more processing devices that: use the range data to generate pose data indicative of a position and orientation of the payload relative to the environment; use the pose data and the flight plan data to identify manoeuvres that can be used to execute the flight plan; generate control instructions in accordance with the manoeuvres; and, transfer the control instructions to a vehicle control system of the aerial vehicle via the communications interface, to cause the aerial vehicle to implement the manoeuvres and thereby fly autonomously in accordance with the desired flight plan, and wherein the range data is further for use (for example, by one or more of the processing devices) in generating a map of the environment.

In one embodiment the system includes at least one of: a movement sensor that generates payload movement data indicative of a payload movement; an orientation sensor that generates payload orientation data indicative of a payload orientation; an inertial measurement unit that generates at least one of payload movement data and payload orientation data; and, a position sensor that generates payload position data indicative of a payload position.

In one embodiment the one or more processing devices identify the manoeuvres using pose data and at least one of: payload orientation data; payload movement data; and, payload position data.

In one embodiment the one or more processing devices modify pose data using at least one of: payload orientation data; payload movement data; and, payload position data.

In one embodiment the one or more processing devices: use the range data and pose data to generate a depth map indicative of a minimum range to the environment in a plurality of directions; and, identify the manoeuvres in accordance with the depth map to thereby perform collision avoidance.

In one embodiment the one or more processing devices perform collision avoidance in accordance with at least one of: an extent to the vehicle; and, an exclusion volume surrounding an extent of the vehicle.

In one embodiment the one or more processing devices determine the extent of the vehicle using at least one of: configuration data; calibration data; and, the range data.

In one embodiment the one or more processing devices: use the range data and pose data to generate an occupancy grid indicative of the presence of the environment in different voxels of the grid; and, identify the manoeuvres using the occupancy grid.

In one embodiment the one or more processing devices at least one of identify manoeuvres and generate control instructions using configuration data indicative of characteristics of the vehicle and vehicle control system.

In one embodiment the one or more processing devices retrieve the configuration data from a data store based on at least one of: a vehicle type; and, a vehicle control system type.

In one embodiment the one or more processing devices determine at least one of manoeuvres and control instructions using calibration data indicative of at least one of: a relative position and orientation of the payload and the vehicle; and, an overall weight.

In one embodiment the one or more processing devices perform calibration by: comparing vehicle orientation data obtained from a vehicle orientation sensor to payload orientation data to determine a relative orientation of the vehicle and payload; comparing vehicle movement data obtained from a vehicle movement sensor to payload movement data to determine a relative position of the vehicle and payload; and, generating calibration data indicative of the relative position and orientation of the payload and vehicle.

In one embodiment the one or more processing devices acquire the vehicle orientation data and vehicle movement data from vehicle sensors via the communications module.

In one embodiment the one or more processing devices determine at least one of the payload orientation data and payload movement data at least in part using the pose data.

In one embodiment the one or more processing devices acquire the vehicle orientation data and the payload orientation data at least one of: while the vehicle is static; and, synchronously.

In one embodiment the one or more processing devices synchronously acquire the vehicle movement data and the payload movement data during movement of the vehicle.

In one embodiment the set movement of the vehicle is performed at least one of: by manually moving the vehicle; and, by causing the vehicle to fly a sequence of predetermined manoeuvres.

In one embodiment the one or more processing devices generate calibration data by comparing a measured vehicle response to an expected vehicle response associated with a control instruction.

In one embodiment the one or more processing devices determine at least one of a vehicle type and a vehicle control system type by at least one of: querying the vehicle control system; and, in accordance with user input commands.

In one embodiment the one or more processing devices determine a data quality by at least one of: analysing at least one of: range data; and, a point cloud derived from the range data; and, comparing movement determined from the pose data to movement data measured using a movement sensor.

In one embodiment the one or more processing devices determine the flight plan using at least one of: configuration data; an environment map generated using the range data; a vehicle control system status; a vehicle status; a data quality; and, a mission status.

In one embodiment the one or more processing devices determine the flight plan at least in part using flight plan data stored in memory, wherein the flight plan data defines at least one of: a mapping flight plan; an abort flight plan; and, a return to home flight plan.

In one embodiment the one or more processing devices determine a vehicle control system status by at least one of: querying the vehicle control system; attempting to communicate with the vehicle control system; and, comparing a measured vehicle response to an expected vehicle response associated with a control instruction, the measured vehicle response being determined using at least one of: pose data; movement data; and, orientation data.

In one embodiment the one or more processing devices determine the vehicle status by at least one of: querying the vehicle control system; and, comparing a measured vehicle response to an expected vehicle response associated with a control instruction, the measured vehicle response being determined using at least one of: pose data; movement data; and, orientation data.

In one embodiment the control instructions are indicative of at least one of: a waypoint; a set altitude; a set velocity; a set attitude and thrust; and, motor control settings.

In one embodiment the one or more processing devices communicate with the vehicle control system via an API.

In one embodiment the payload includes a mounting to attach the payload to the vehicle.

In one embodiment the range sensor is configured to operate in first and second orientations, wherein in the first orientation the range sensor is positioned under the payload and in the second orientation the range sensor is positioned laterally relative to the payload.

In one embodiment the range sensor is a Lidar sensor.

In one broad form an aspect of the present invention seeks to provide a method of performing mapping and controlling an aerial vehicle using a payload attachable to the aerial vehicle, the payload including: a range sensor that generates range data indicative of a range to an environment; a memory for storing flight plan data indicative of a desired flight plan; a communications interface; and, one or more processing devices, wherein the method includes, in the one or more processing devices: using the range data to generate pose data indicative of a position and orientation of the payload relative to the environment; using the pose data and the flight plan data to identify manoeuvres that can be used to execute the flight plan; generating control instructions in accordance with the manoeuvres; and, transferring the control instructions to a vehicle control system of the aerial vehicle via the communications interface, to cause the aerial vehicle to implement the manoeuvres and thereby fly autonomously in accordance with the desired flight plan, and wherein the range data is further for use in generating a map of the environment.

In one broad form an aspect of the present invention seeks to provide a method of calibrating a mapping and control system for an aerial vehicle, the system including a payload attachable to the aerial vehicle, the payload including: a range sensor that generates range data indicative of a range to an environment, the range data being usable in generating a map of the environment; a memory for storing flight plan data indicative of a desired flight plan for mapping the environment; a communications interface; and, one or more processing devices, wherein the method includes, in the one or more processing devices: acquiring from vehicle sensors, via the communications module: vehicle orientation data indicative of a vehicle orientation; and, vehicle movement data indicative of vehicle movement; acquiring: payload orientation data indicative of a payload orientation; and, payload movement data indicative a payload movement; comparing the vehicle orientation data and payload orientation data to determine a relative orientation of the vehicle and payload; comparing the vehicle movement data and payload movement data to determine a relative position of the vehicle and payload; and, generating calibration data indicative of the relative position and orientation of the payload and vehicle, wherein the calibration data is used in at least one of mapping and controlling the aerial vehicle.

In one embodiment the method includes: using the range data to generate pose data indicative of a position and orientation of the payload relative to the environment; and, determining at least one of the payload orientation data and payload movement data at least in part using the pose data.

In one embodiment the method includes determining at least one of the payload orientation data and payload movement data using at least one of: a position sensor; a movement sensor; an orientation sensor; and, an inertial measurement unit.

In one embodiment the method includes acquiring the vehicle orientation data and the payload orientation data at least one of: while the vehicle is static; and, synchronously.

In one embodiment the method includes synchronously acquiring the vehicle movement data and the payload movement data during movement of the vehicle.

In one embodiment movement of the vehicle is performed at least one of: by manually moving the vehicle; and, by causing the vehicle to fly at least one predetermined manoeuvres.

In one embodiment the one or more processing devices generate calibration data by comparing a measured vehicle response to an expected vehicle response associated with a control instruction.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

Various examples and embodiments of the present invention will now be described with reference to the accompanying drawings, in which: -

FIG. 1A is a schematic diagram of an example of a mapping and control system for an aerial vehicle;

FIG. 1B is a schematic diagram of a further example of a mapping and control system for an aerial vehicle;

FIG. 2A is a flowchart of an example of a process for calibrating and/or configuring a mapping and control system for an aerial vehicle;

FIG. 2B is a flowchart of an example of a process for performing mapping and controlling an aerial vehicle;

FIG. 3 is a schematic diagram of internal components of the mapping and control system;

FIGS. 4A to 4C are a flowchart of a specific example of a process for calibrating the mapping and control system of FIG. 3;

FIG. 5 is a schematic diagram illustrating coordinate frames for the aerial vehicle and the mapping and control system;

FIGS. 6A and 6B are an example of a process for performing mapping and controlling an aerial vehicle using the mapping and control system of FIG. 3; and

FIG. 7 is a schematic diagram of an example of the functional operation of a mapping and control system.

### DETAILED DESCRIPTION OF THE PREFERRED EMBODIMENTS

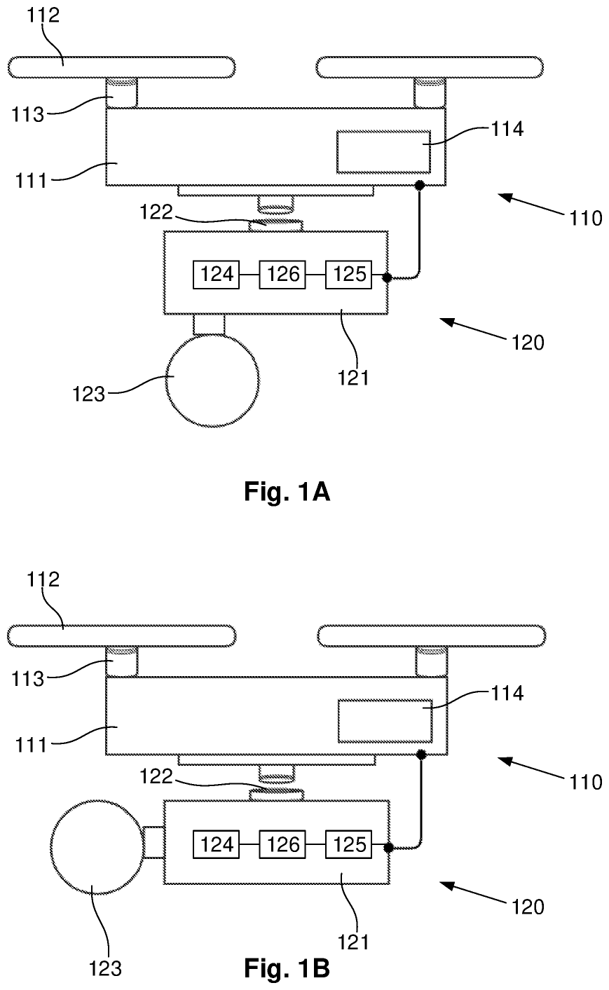

An example of a mapping and control system for an aerial vehicle will now be described with reference to FIGS. 1A and 1B.

In these examples, an aerial vehicle 110 is provided including a body 111, such as an airframe or similar, having a number of rotors 112 driven by motors 113 attached to the body 111. The aerial vehicle 110 includes an inbuilt aerial vehicle control system 114, which may include one or more sensors such as a GPS (Global Positioning System) sensor, orientation sensors, such as an IMU, optical sensors, such as cameras, or the like. Signals from the sensors are typically used by associated processing and control electronics to control the motors 113, and hence control the attitude and thrust of the vehicle. The vehicle control system is typically adapted to operate in accordance with input commands received from a remote control system, or similar, optionally with a degree of autonomy, for example to implement collision avoidance processes, navigate to defined waypoints, or the like. It will be appreciated from this that in one example the aerial vehicle 110 can be a commercially available drone, and as the operation of such drones is well known, features of the aerial vehicle 110 will not be described in further detail.

In this example, a mapping and control system 120 is provided, which includes a payload 121 that is attached to the aerial vehicle 110, typically via a mounting 122, although any suitable attachment mechanism may be used. The payload includes a range sensor 123, such as a Lidar sensor, although other sensors capable of detecting a range to the environment, such as a stereoscopic imaging system, could be used.

The payload 121 further contains one or more memories 124, such as volatile and/or non-volatile memory, which can be used for storing flight plan data indicative of one or more desired flight plans, and which may also be used for storing collected data. A communications interface 125 is provided to allow for communication with the vehicle control system 114. The nature of the communications interface will vary depending on the preferred implementation and the nature of connectivity associated with the vehicle control system. Furthermore, although a single communications module is shown, this is for the purpose of example only, and in practice multiple interfaces using various methods (e.g. Ethernet, serial, USB, wireless, or the like) may be provided.

The payload also includes one or more processing devices 126, coupled to the memory 124 and the communications interface 125. The processing devices 126 could be any electronic processing device such as a microprocessor, microchip processor, logic gate configuration, firmware optionally associated with implementing logic such as an FPGA (Field Programmable Gate Array), or any other electronic device, system or arrangement. The processing devices 126 communicate with the vehicle control system 114 using the communications module 125, typically by interfacing with an Application Programming Interface (API) of the vehicle control system; although it will be appreciated that any suitable technique could be used. For ease of illustration the remaining description will make reference to a processing device, but it will be appreciated that multiple processing devices could be used, with processing distributed between the devices as needed, and that reference to the singular encompasses the plural arrangement.

In the example of FIG. 1A, the payload 121 is attached to an underside of the body 111, with the range sensor 123 located below the payload. In contrast, in the arrangement of FIG. 1B the range sensor 123 is laterally offset from the payload 121. It will be appreciated that as a result these different arrangements provide different fields of view for the range sensor 123, which can provide certain benefits in different applications. For example, mounting the range sensor 123 below the payload 121 tends to provide a wider field of view over the ground below the vehicle, which is more suitable for ground based mapping, whereas lateral positioning of the range sensor 123 provides a field of view in front of the vehicle, which can provide more effective collision avoidance, and hence is more useful for mapping in congested environments, such as underground, or the like. In one example, the Lidar can be movably mounted to the payload, allowing the Lidar to be moved between the orientations shown in FIGS. 1A and 1B, either manually, or using an actuator, such as a stepper motor or similar. It will also be appreciated that other mounting configurations could be used, depending on the nature of the vehicle and the application for which it is to be used, and the above examples, whilst illustrative, are not intended to be limiting.

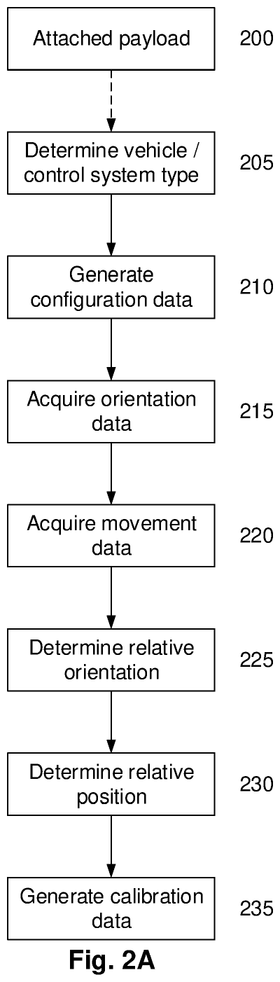

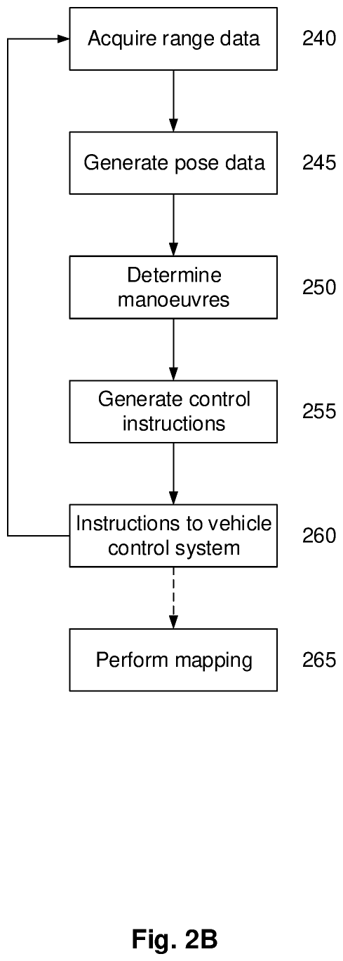

An example of a process for calibrating and/or configuring a mapping and control system will now be described with reference to FIG. 2A.

In particular, in this example it is assumed that the mapping and control system is in a discrete form and attachable to the aerial vehicle in a “plug and play” configuration, meaning it can be simply attached to the aerial vehicle and used with no or only minimal set-up.

In this example, the range payload is initially attached to the vehicle at step 200, with a calibration and/or configuration process being performed, to thereby configure the system for use with the aerial vehicle based on the mounting configuration.

In this example, to perform configuration, at step 205, the processing device 126 can determine a vehicle type and/or a vehicle control system type. This can be performed in any appropriate manner, and could be achieved by communicating with the vehicle control system and/or based on user input commands.

At step 210, this is used to retrieve configuration data, which may be either stored locally in the memory 124, or could be retrieved from a remote data store, such as a database. The configuration data used can be indicative of characteristics of the vehicle and/or vehicle control system, and can include information such as flight capabilities of the vehicle or vehicle control system, control instruction formats, or the like. The configuration data can be used in order to allow the control system 120 to automatically configure itself to operate with the respective vehicle and/or vehicle control system. Again however, it will be appreciated that this step would not be required in the event that the control system 120 is configured for use with a single vehicle and/or vehicle control system.

To perform calibration, at step 215 the processing device 126 acquires vehicle orientation data indicative of a vehicle orientation and payload orientation data indicative of a payload orientation. Similarly, at step 220, the processing device 126 acquires vehicle movement data indicative of vehicle movement and payload movement data indicative a payload movement. In one example movement data is in the form of a 3D velocity vector for the vehicle and payload respectively, although other forms of movement data could be used depending on the preferred implementation. The vehicle orientation and movement data is typically received via the communications module, for example, by having the processing device 126 query the vehicle control system. The payload orientation and movement data can be obtained from on-board sensors, and could be derived from pose data generated using range data from the range sensor, or using data from another sensor, such as an inertial measurement unit (IMU), or the like.

At step 225 the processing device 126 compares the vehicle orientation data and payload orientation data to determine a relative orientation of the vehicle and payload. Similarly, at step 230, the processing device 126 compares the vehicle movement data and payload movement data to determine a relative position of the vehicle and payload. In this example, orientation and position calibration are performed separately, for example allowing the orientation calibration to be performed while the vehicle is static, but this is not essential and in some examples, the calibration steps could be performed simultaneously. Following this at step 235, the processing device 126 generates calibration data indicative of the relative position and orientation of the payload and vehicle. This allows the calibration data to be used in mapping and/or controlling the aerial vehicle, for example to translate a vehicle position calculated based on payload sensors, into a coordinate frame of the vehicle.

For example, if forward directions of the vehicle and payload are offset, and the payload generates an instruction to travel in a forward direction, the payload will detect lateral movement, and attempt to correct for this by turning the vehicle. As this will cause the vehicle to fly in an incorrect direction, further corrections will be required, in turn leading the vehicle oscillating about the forward direction. However generating calibration data in the manner described above can avoid this issue, allowing the mapping and control system to automatically translate instructions into the coordinate frame of the vehicle and thereby ensure accurate instruction and response of the vehicle. Thus, the use of the calibration process can facilitate the plug and play nature of the mapping and control system, allowing this to operate effectively even in the event that the payload 121 and aircraft 110 are not accurately aligned.

Additionally, calibration can help determine the position of the control system 120, which in turn can impact of flight characteristics of the vehicle. For example, the centre of mass of the control system will be offset from the centre of mass of the vehicle and optionally, also from the centre of thrust of the vehicle. As a result, this can have an impact on the flight characteristics of the vehicle, for example inducing the vehicle to pitch or roll. However, by knowing the location of the payload, this can allow the control system to compensate for the offsets.

Nevertheless it will be appreciated that calibration may not be required in the event that the payload 121 can be attached to the aircraft at a fixed known position and orientation, in which case control of the vehicle can be performed using this information, without any requirement for calibration.

Once attached and optionally calibrated and/or configured, the mapping and control system can be used to perform mapping and control of the vehicle, and an example of this will now be described with reference to FIG. 2B.

In this regard, at step 240, during flight the mapping control system acquires range data generated by the range sensor 123, which is indicative of a range to an environment. It will be appreciated that the format of the range data will depend on the nature of the range sensor 123, and some processing may be required in order to ensure the range data is in a format suitable for downstream processing, for example to convert stereoscopic images to depth information.

At step 245, the processing device 126 generates pose data indicative of a position and orientation of the payload relative to the environment, using the range data. It will be appreciated that pose data can be generated from the range data utilising a simultaneous localisation and mapping (SLAM) algorithm or any other suitable approach and as such techniques are known, these will not be described in any further detail. In one particular example, this involves generating a low resolution map, which can be used for mapping purposes, although this is not necessarily essential.

Having determined pose data, at step 250, the processing device 126 then uses this, together with flight plan data, to identify manoeuvres that can be used to execute the flight plan. For example, the flight plan may require that the aerial vehicle fly to a defined location in the environment, and then map an object. In this instance, the current pose is used to localise the payload, and hence vehicle, within the environment, and thereby ascertain in which direction the vehicle needs to fly in order to reach the defined location. The processing device 126 interprets this as one or more manoeuvres, for example including a change in attitude and/or altitude of the vehicle, and then flying at a predetermined velocity for a set amount of time. Further manoeuvres to achieve the mapping can then be identified in a similar manner.

At step 255 the processing device 126 generates control instructions based on the manoeuvres, with the control instructions being transferred to the vehicle control system 114 at step 260 in order to cause the aerial vehicle to implement the manoeuvres. The nature of the control instructions may vary depending on the preferred implementation and the capabilities of the vehicle control system. For example the vehicle control system may require instructions in the form of an indication of a desired vehicle thrust and attitude. Alternatively however the vehicle control system may include a degree of built-in autonomy in which case the instructions could direct the vehicle control system to fly in a defined direction at a defined speed.

It will be appreciated that the steps of determining the manoeuvres and control instructions can take into account calibration data, so that data captured from sensors on the payload is interpreted into control instructions in the coordinate frame of the vehicle, to ensure correct responsiveness of the vehicle. However, this is not essential, and may not be required for example, if the payload is attached to the vehicle in a known position and orientation. Additionally, this process can optionally take into account the configuration data, ensuring instructions are generated in a correct manner, and to ensure the manoeuvres are within the flight capabilities of the vehicle. Again however, this may not be required, for example if the system is adapted to operate with a single vehicle type and/or vehicle control system type.

The above steps 240 to 260 are repeated, allowing the vehicle to be controlled in order to execute a desired mission, for example to collect range data for use in generating a map of an environment.

Additionally, at step 265 the range data can be utilised in order to perform mapping of the environment. Mapping can be performed utilising a SLAM algorithm and it will therefore be appreciated from this that the range data acquired at step 240 from the range sensor can be utilised to perform both control of the aerial vehicle and mapping of the environment. Indeed, the step of generating the pose data at step 245 could involve the use of a SLAM algorithm, in which case mapping could be performed concurrently as part of the control process. However, this is not necessarily essential and in alternative examples, a low resolution SLAM process may be performed in order to generate the pose data for control purposes, with the range data being stored and used to perform a higher resolution SLAM process in order to perform mapping of the environment at a subsequent stage, for example after a flight has been completed.

In any event, it will be appreciated that the above described mapping and control system can be attached to an aerial vehicle and used to control the aerial vehicle in flight while simultaneously provide mapping functionality. This allows an existing aerial vehicle with little or no autonomy and/or no mapping capabilities, to be easily adapted for use in autonomous mapping applications. In particular, the payload can simply be attached to the aerial vehicle, a calibration and/or configuration process optionally performed if required, and then the vehicle is able to autonomously map an area. It will be appreciated that at the end of this process, the payload can then be removed from the aerial vehicle and optionally used with other aerial vehicles as required.

Accordingly, this allows the payload to integrate the sensors and processing electronics required in order to implement mapping and control functionality, whilst allowing the aerial vehicles to utilise lower cost components. This avoids the need for high cost sensing and electronics to be integrated into multiple aerial vehicles, allowing an organisation to maintain cheaper aerial vehicles whilst still enabling a mapping and control system to be provided. This is particularly beneficial in the event that vehicles become damaged or fail, as the expensive sensing system can simply be attached to another vehicle, with the damaged vehicle being repaired and/or replaced, without interrupting mapping operations.

Furthermore, through appropriate configuration, the mapping and control system can be configured for use with different aerial vehicles and/or different aerial vehicle control systems allowing this to be employed in a wide range of scenarios and with different aerial vehicles most suited for particular applications, providing a greater degree of flexibility than has traditionally been achievable using integrated control and mapping systems.

A number of further features will now be described.

In one example, the system includes a movement sensor that generates payload movement data indicative of payload movement and/or an orientation sensor to generate payload orientation data indicative of payload orientation. In one particular example the movement and orientation sensors are included as a single inertia measurement unit (IMU) which is able to generate a combination of payload movement and orientation data. In these examples, the processing device 126 can use the pose data together with the payload movement and/or payload orientation data to identify the manoeuvres. In this regard, whilst payload movement and orientation could be derived solely from the pose data, further measuring movement and/or orientation of the payload independently can help improve the accuracy and robustness of the measurements, for example avoiding glitches in the SLAM algorithm, which might otherwise inadvertently affect the control of the vehicle. In one particular example, this is achieved by using the pose data and data from the IMU to modify the pose data, effectively producing fused pose data, which tends to be more accurate than pose data generated from the SLAM algorithm alone.

Additionally, and for similar reasons the system can include a position sensor such as a GPS sensor, that generates position data indicative of a payload position with the position and pose data being used together to identify the manoeuvres.

In one example, the one or more processing devices use range data and pose data together to generate a depth map indicative of a minimum range to the environment in a plurality of directions, for example over a spherical shell surrounding the aerial vehicle. Manoeuvres can then be identified in accordance with the depth map in order to perform collision avoidance. Such collision avoidance also typically takes into account an extent of the vehicle and in a more particular example an exclusion volume surrounding an extent of the vehicle. In particular, this is performed for two main purposes, namely to avoid intersection of the exclusion volume with part of the environment, to thereby prevent a collision, as well as to avoid measuring the range of features within the exclusion volume, which would typically correspond to features of the drone itself as opposed to the environment.

In one example, the processing device 126 determines the extent of the vehicle using configuration and calibration data. In particular, the configuration data can specify details of the aerial vehicle, such as the size or shape of the aerial vehicle, based on the aerial vehicle type. In this instance, the extent of the vehicle relative to the payload may be calculated using the calibration data, to thereby take into account the relative position or orientation of the payload and vehicle. Alternatively, the extent of the vehicle can be determined based on range data measured by the range sensor 123. For example this could be achieved by identifying points in a point cloud that are positioned within a certain envelope, such as a certain distance from the vehicle and/or sensor, and/or which are invariant even after movement of the vehicle. Thus in this instance, the extent of the vehicle is detected using the mapping and control system 120 itself. It will also be appreciated that a combination of these approaches could be used.

In addition to performing collision avoidance, the processing device 126 also typically uses the range and pose data to generate an occupancy grid indicative of the presence of the environment in different voxels of a grid extending outwardly in three dimensions from the vehicle. The processing device 126 then identifies manoeuvres using the occupancy grid. In contrast to the collision avoidance which is only concerned with a minimum distance to surrounding objects, the occupancy grid is used to examine the presence of an environment over a greater depth, with this being used in order to identify manoeuvres that can be used to implement a flight plan, for example to plot a path to a defined location.

The one or more processing devices can identify the manoeuvres and/or generate control instructions using configuration data indicative of characteristics of the vehicle and vehicle control system. The configuration data can be indicative of the vehicle extent, as well as additional characteristics of the vehicle, such as flight capabilities of the vehicle, including maximum velocities, turning rates, flight times, or the like. Similarly, the configuration data can be indicative of characteristics of the vehicle control system, such as degrees of autonomy available, control instruction formats, or the like. The one or more processing devices 126 typically retrieve the configuration data from a data store, such as the memory 124, based on a vehicle type and/or a vehicle control system type. Thus this information can be used to retrieve configuration data from a number of profiles stored on board the payload, allowing the control system 120 to easily operate with a range of different vehicle types and vehicle control system types. As mentioned above, the vehicle type or vehicle control system type can be determined either in accordance with user input commands, by querying the vehicle control system, or by using any other suitable technique.

The processing device 126 also typically identifies manoeuvres and/or generates control instructions using the calibration data, which can be generated using the process described above. Alternatively, the calibration could be fixed based on a known position and orientation of the payload, for example in the event that the mounting 122 sufficiently constrains the payload position and orientation.

When generating calibration data, the processing device 126 typically operates to acquire the vehicle orientation and movement data from the vehicle control system 114 via the communications module 125.

To allow the relative vehicle and payload orientation to be determined, it is necessary to be able to compare the vehicle and payload orientation data directly, meaning this is preferably achieved by collecting the data whilst the orientation is constant. This can be achieved by collecting the data vehicle and payload orientation data synchronously, for example by time synchronising the mapping and control system with the vehicle control system, allowing the orientation to be determined when the vehicle is static, or when the vehicle is moving. Additionally and/or alternatively, this can be achieved by ensuring the vehicle remains static whilst the vehicle and payload orientation data are collected, in which case exact synchronisation of the measurements is not required. In either case, calibration can be achieved by simply determining a geometric transformation between the two orientations. However, it will also be appreciated that this is not essential and alternative approaches could be used.

In the case of the vehicle and payload movement data, as this should be collected whilst the vehicle is moving, this typically requires that the vehicle and payload movement data are collected synchronously. This can be achieved by synchronising the control systems, or could be achieved based on movement of the vehicle, for example by using data collected a set time interval after a particular manoeuvre, such as a rotation, has been completed. Thus, in this instance, data could be collected during a sequence of movements, with the processing device 126 analysing the vehicle and payload movement data to identify a particular manoeuvre in both data sets, using this information to synchronise the data sets, and thereby allow direct comparison.

Movement of the vehicle can be performed in any one of a number of ways, and could be achieved by manually moving the vehicle, either by hand, or using equipment, such as another vehicle to support the aerial vehicle. Additionally and/or alternatively, this could be performed by having the vehicle complete one or more defined manoeuvres.

Additionally and/or alternatively, calibration could be achieved by comparing a measured vehicle response to an expected vehicle response associated with a control instruction. For example, the vehicle could be instructed to fly north, with a deviation between the measured direction of travel and north being used to determine the relative payload and vehicle orientation. In these examples, the measured vehicle response can be determined using the pose data, movement data or orientation data, either obtained from payload sensors and/or vehicle sensors.

In addition to calibrating the payload position and/or orientation, calibration can also be performed in order to calibrate the thrust response of the aircraft. This can be utilised to take into account that the vehicle may be supporting additional payloads, and hence there is a difference in the actual thrust response, compared to the thrust response that would be expected based on the vehicle configuration and the weight of the mapping and control system payload. In this instance, such thrust calibration can be measured by instructing the vehicle to perform a manoeuvre, such as hovering, and then monitoring whether the vehicle is stationary, or is rising or falling. The vertical movement as monitored is used to adjust a thrust command to be sent to a vehicle control system, providing a feedback loop to allow future thrust commands to be scaled based on the vehicle response. The above steps may be repeated for a predetermined period of time or until the vertical movement is below a predetermined threshold.

In operation, the processing device 126 can determine the flight plan utilising a combination of different techniques. This could take into account configuration data, for example, based on flight capabilities of the vehicle, an environment map generated using the range data, a vehicle control system status, vehicle status, a mission status, a data quality, or the like. For example, the processing devices could be given a mission to perform mapping of an object. The flight plan will then be developed based on the location of the object within the environment and the presence of obstacles in the environment. Additionally, this can also take into account flight capabilities of the vehicle, as well as the current status of the vehicle control system and vehicle. For example, this could include utilising a mapping flight plan to perform the mapping and then using an abort or return to home flight plan for example when mapping is completed, or in the event of a problem arising, such as in the case of vehicle tracking errors, a low battery charge level, or the like.

Thus, the processing device 126 can be configured to determine a vehicle control system status and or vehicle status, and use this as part of the planning process, for example selecting different flight plan data if the vehicle status is healthy or unhealthy. The vehicle control system status and/or vehicle status can be determined by querying the vehicle control system, for example to determine details of any self-identified errors, attempting to communicate with the vehicle control system to ensure the communication link is still functioning effectively, or by comparing a measured vehicle response to an expected vehicle response associated with a control instruction. Thus for example, if an instruction is provided and the vehicle responds in an unexpected manner, this could be indicative of a fault in which case an abort or return to home flight plan could be implemented.

A similar process could also be performed to take into account the quality of the data being collected. For example, if the control system 120 is attempting to map an object, and the range data is of a poor quality and/or does not correctly capture the object, the processing device 126 can be adapted to repeat the previous manoeuvres in an attempt to improve the data captured. Additionally and/or alternatively, different manoeuvres could be used in order to attempt to improve the data capture. It will be appreciated that this is possible because the range data is used in the control process, so analysis of the range data as part of the control process can be used to assess data quality. For example, if there is significant deviation between movements derived from the pose data as opposed to movements measured by the IMU, then this can indicate that there are potential inaccuracies in the SLAM solution, such as a low resolution point cloud, derived from the range data, in which case data collection could be repeated.

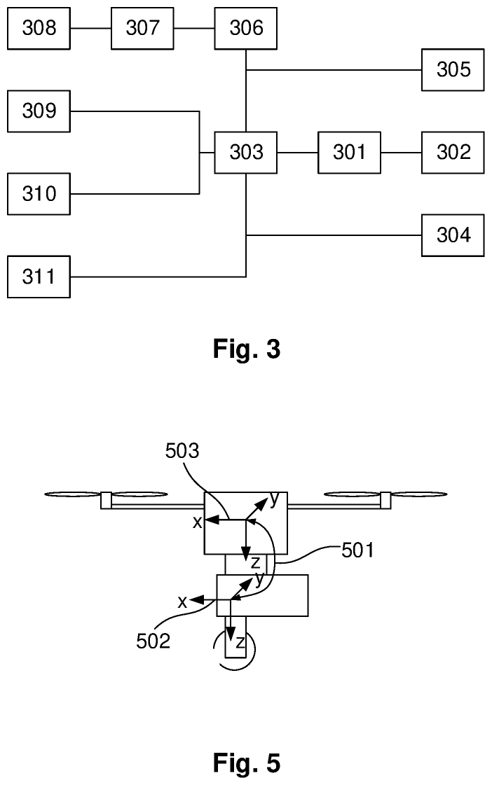

Further details of an example of the internal components of the control system payload will now be described with reference to FIG. 3.

In this example, the control system includes one or more processing devices 301, coupled to one or more communications modules 302, such as a USB or serial communications interface, and optional wireless communications module, such as a Wi-Fi module. The processing device 301 is also connected to a control board 303, which provides onward connectivity to other components, for example generating control signals for controlling operation of the sensors, and at least partially processing sensor signals. For example, the control board 303 can be connected to an input/output device 304, such as buttons and indicators, a touch screen, or the like, and one or more memories 305, such as volatile and/or non-volatile memories. The control board 303 is also typically coupled to a motor 307 for controlling movement of the Lidar sensor 308, to thereby perform scanning over a field of view, and an encoder 306 for encoding signals from the Lidar sensor 308. An IMU 309 is also provided coupled to the control board 303, together with optional cameras and GPS modules 310, 311.

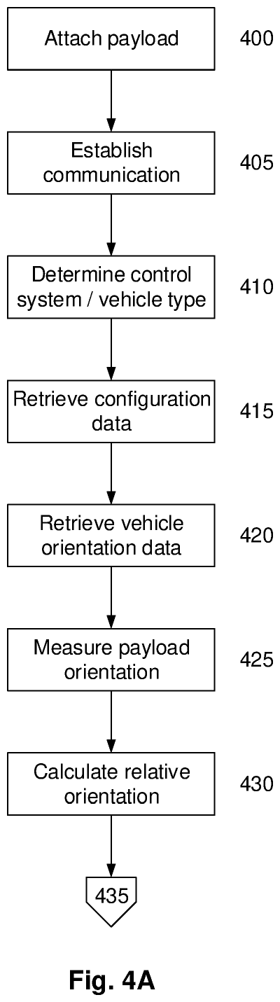

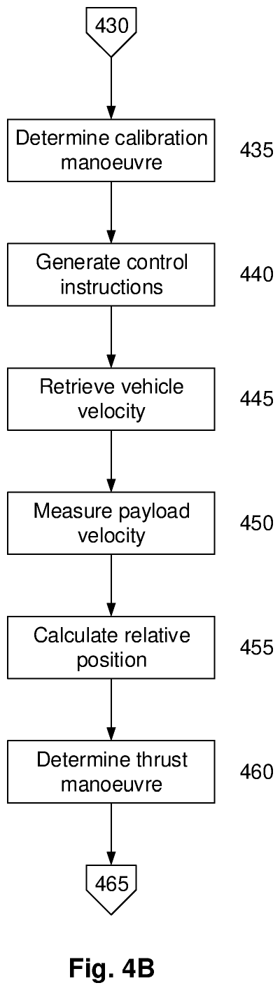

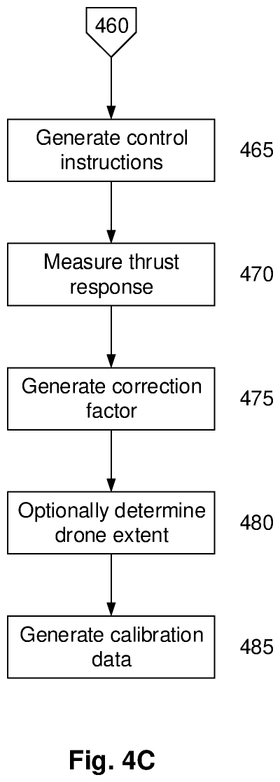

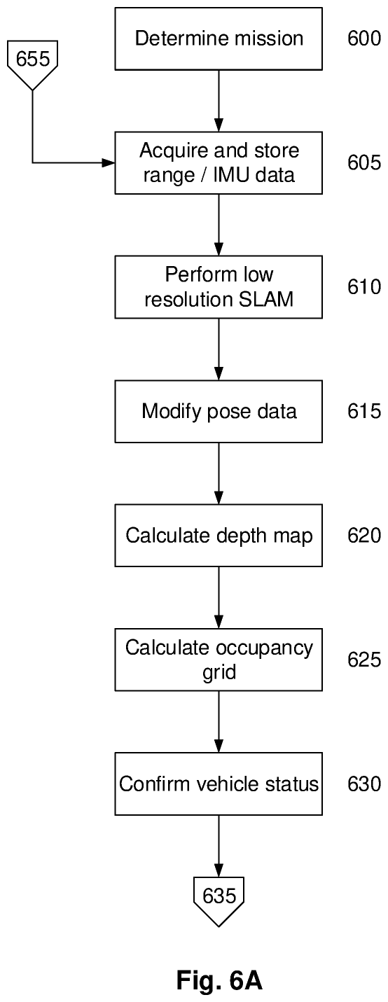

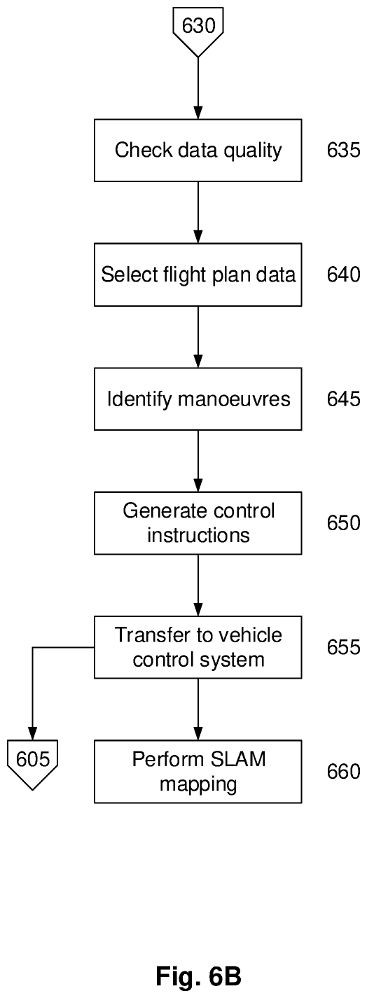

It will be appreciated that these operate largely as described above, and the operation for calibration and flight control will now be described in more details with reference to FIGS. 4A to 4C and 6A and 6B, respectively.

In this example, at step 400 the payload is attached to the vehicle with communication between the processing device 301 and the vehicle control system 114 being established via the communications module 302 at step 405. This will typically involve having the processing device 301 generate a series of API requests corresponding to different vehicle control system types, with the vehicle control system responding when an appropriate request is received. This allows the processing device 301 to determine the control system type and optionally the vehicle type at step 410, although alternatively this could be achieved in accordance with manually input commands, provided via the input/output device 304, if this cannot be performed automatically.

The control system type and vehicle type are used to retrieve configuration data for the vehicle and vehicle control system at step 415, allowing this to be used in generating manoeuvres and control instructions in the remaining part of the calibration process.

At step 420 the processing device 301 retrieves a vehicle orientation from an on-board vehicle orientation sensor, by for example by querying the vehicle control system. Simultaneously, at step 425, a payload orientation is determined from the on board IMU 309, with the processing device 301 using the vehicle and payload orientation to determine a relative orientation at step 430.

At step 435 a calibration manoeuvre is determined, with this being used to generate control instructions at step 440. The calibration manoeuvre is typically a defined sequence of manoeuvres that are pre-set as part of the calibration routine, and may be retrieved from the memory 305. The one or more manoeuvres may also be customised for the particular vehicle control system and/or vehicle, to optimise the calibration process, whilst ensuring the vehicle flight is safe taking into account that calibration is not complete.

At step 445, while the manoeuvres are being performed, the processing device 301 retrieves a vehicle velocity from on board vehicle movement sensors, and determines a payload velocity at 450, utilising pose data generated from range data, or signals from the IMU 309. The vehicle velocity and payload velocity are used in order to calculate a relative position of the payload and vehicle at step 455. In particular, this is used to determine an offset between the payload and vehicle so that a translation 501 can be determined between a payload coordinate frame 502 and vehicle coordinate 503 as shown in FIG. 5.

Following this, thrust calibration is performed by having the processing device 301 determine a defined thrust manoeuvre at step 460, such as hovering, climbing or descending at a set velocity, or the like, and generate control instructions at step 465. A thrust response is determined at step 470, for example by monitoring movement of the vehicle using the payload sensors, such as the IMU 309 and/or Lidar 308, with this being used to generate a thrust correction factor at step 475.

Additionally, at step 480 a vehicle extent can also be measured using range data collected by the Lidar 308, for example if this is not available in the configuration data.

The translation 501, and optionally thrust correction factor and vehicle extent can be saved as calibration data at step 485.

An example of a control mapping process will now be described with reference to FIG. 6A and 6B. For the purpose of this example, it is assumed that the above described calibration process has already been performed.

In this example, at step 600 a mission is determined. The mission will typically be specified by the user and may be loaded into the payload memory 305 from a remote computer system, or may be transmitted to the mapping and control system in flight, via the communications module, or the like. The mission can be defined at a high level and may for example specify that the vehicle is to be used to map a predefined object at a certain location, or may include additional information, such as including one or more flight plans.

At step 605, range and movement and orientation data are obtained from the Lidar and IMU 308, 309, with these typically being stored in the memory 305, to allow subsequent mapping operations to be performed. The range data is used by the processing device 301 to implement a low resolution SLAM algorithm at step 610, which can be used to output a low resolution point cloud and pose data. The pose data can be modified at step 615, by fusing this with movement and/or orientation data from the IMU to ensure robustness of the measured pose.

At step 620, the processing device 301 calculates a depth map, which involves determining a minimum range to the environment for directions surrounding the vehicle. In this regard, the range data will be parsed to identify a minimum range in a plurality of directions around the vehicle. At step 625, the processing device 301 calculates an occupancy grid including an occupancy in voxels for a three dimensional grid around the vehicle. This is typically achieved by segmenting the point cloud and examining for the presence of points within the different voxels of a three dimensional grid surrounding the vehicle. This is used to identify obstacles around the vehicle, allowing paths along which the vehicle can fly to be identified.

At step 630 the processing device 301 confirms a vehicle status by querying the vehicle control system, and examining the pose data to ensure previous control instructions have been implemented as expected. At step 635, the quality of the collected data is examined, for example by ensuring the range data extends over a region to be mapped, and to ensure there is sufficient correspondence between the movements derived from pose data and measured by the IMU.

At step 640, a flight plan data is selected taking into account the depth map, the occupancy grid, the vehicle status, the data quality, and the current mission. For example, by default a primary flight plan would be selected in order to achieve the current mission, such as selecting a flight plan to allow a defined area or object to be mapped. However, this will be modified taking into account the vehicle status, so, for example, if the processing device 301 determines the vehicle battery has fallen below a threshold charge level, the primary mapping mission could be cancelled, and a return to home flight plan implemented, to return the vehicle to a defined home location before the battery runs out. Similarly, if it is identified that the data being collected is not of a suitable quality for downstream mapping, this can be used to allow a previous part of the mission to be repeated in order to collect additional data.

The processing device 301 identifies one or more manoeuvres at step 645 based on the selected flight plan and taking into account the occupancy grid, the configuration data and depth map. Thus, the processing device 301 can determine one or more locations to which the vehicle should travel, plotting a path to the locations based on the occupancy grid and the flight capabilities of the vehicle, using this to determine the manoeuvres required to fly the path. Having determined the manoeuvres, the processing device 301 generates control instructions at step 650, taking into account the calibration data so that instructions are translated into the coordinate frame of the vehicle.

The control instructions are transferred to the vehicle control system at step 655 causing these to be executed so that the vehicle executes the relevant manoeuvre, with the process returning to step 605 to acquire further range and IMU data following the execution of the control instructions.

At the end of this process, the range data can be analysed using a high resolution SLAM algorithm in order to generate a map at step 660. Whilst this can be performed on-board by the processing device 301 in real-time, more typically this is performed after the flight is completed, allowing this to be performed by a remote computer system. This allows a low resolution SLAM process to be used for flight control purposes, enabling more robust approaches to be used in real time, whilst reducing the computational burden on the mapping and control system, reducing hardware and battery requirements, and thereby enabling a lighter weight arrangement to be used. This also reduces latency, making the approach more responsive than would otherwise by the case.

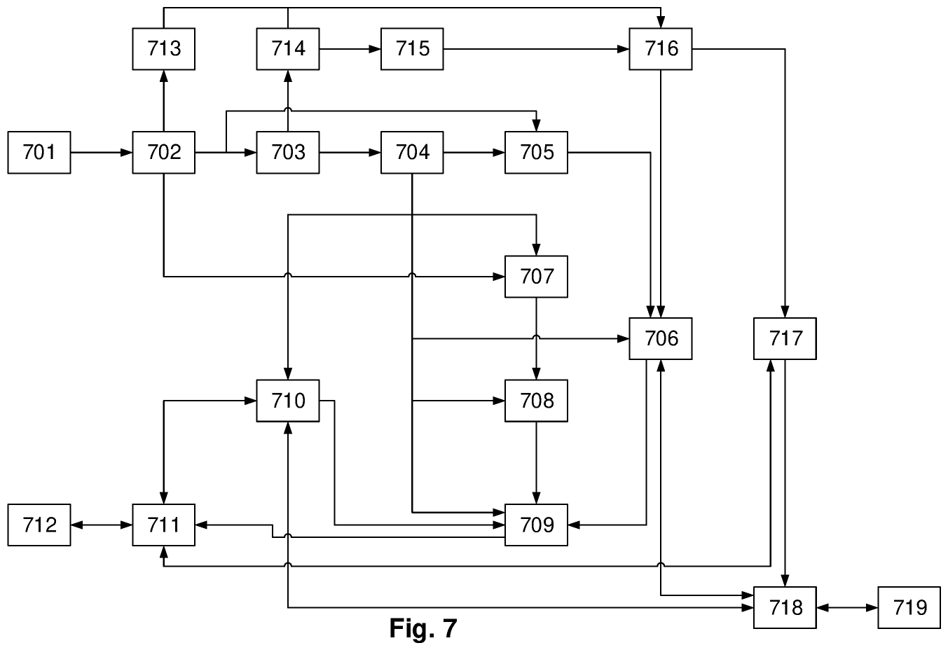

A more in-depth explanation of the functionality of the mapping and control system will now be described with reference to FIG. 7. This makes reference to particular functional modules, which could be implemented in hardware and/or software within the mapping and control system. Furthermore, it will be appreciated that reference to separate modules is for the purpose of illustration and in practice different arrangements of modules could be used to achieve similar processing and outcomes.

In this example, sensor data is obtained from on board sensors 701 and provided to sensor drivers 702 for interpretation. Range data is provided to a SLAM algorithm module 703, which utilises this in order to generate pose data and a low resolution point cloud. The pose data is transferred to a fusion module at step 704, which operates to combine the pose data with movement / orientation data from the IMU, in order to generate fused pose data with a greater accuracy and robustness.

The modified pose data is provided to an occupancy grid module 705, which operates to calculate the occupancy grid, which is then forwarded to a guidance system module 706. In parallel, a spherical depth map is generated based on the Lidar range data by a depth map module 707, which passes this to a collision avoidance module 708 to perform a collision avoidance analysis.

The guidance system identifies manoeuvres based on a current mission providing the manoeuvres to a flight controller 709. The flight controller 709 retrieves configuration and calibration data from a configuration and calibration module 710, and uses this together with results of the collision avoidance analysis and the manoeuvres in order to generate control instructions which are transferred to the vehicle control system 711 and used to control the vehicle 712.

In addition to these processes, simultaneously raw data obtained from the sensor drivers can be stored by a data logging algorithm 713 allowing this to be used in subsequent offline mapping processes. Additionally, the point cloud generated by the SLAM algorithm 703 is provided to a point cloud analysis algorithm 714, which analyses the point cloud and provides the analysed point cloud to a point cloud optimisation algorithm 715, which performs point cloud optimisation and geo referencing. The point cloud, geo referencing and raw data can be used by a mission expert module 716, together with status information from a health monitoring and fail safe module 717, to select a current mission.

The health monitoring and fail safe module 717 interfaces directly with the vehicle controller 711 to confirm the status of the vehicle 712 and vehicle control system 711. The health monitoring and fail safe module 717 can also use information from the mission expert module 716 to assess the quality of collected data and assess whether data collection needs to be repeated. The health monitoring and fail safe module module 717 is also typically connected to a communications interface 718, to allow communication with a ground based user controller 719. This can be used to allow for the user to manually control the mapping process, for example allowing the user to override or modify the mission, make changes to the flight guidance, including manually controlling the vehicle, or the like.

Accordingly, the above described arrangements can provide a plug-and-play 2-in-1 autonomy and mapping payload, which can be attached to an aerial vehicle, such as a drone, to allow the drone to perform autonomous mapping. In one example, this can be used to provide advanced and industrial-grade mapping and autonomy functionalities to relatively basic drones. The integration of autonomy and mapping software into a single payload allows more robust and more accurate mapping and autonomy compared to a case where they are separate. This can further allow for the implementation of mission expert autonomy, taking into account a drone status, the quality of collected data, or the like, for example allowing the drone to be controlled to ensure the quality of the data recorded for mapping purposes.

The above described system can be implemented with different drone platforms from different manufacturers, allowing the platform to be used for multiple different applications and by multiple users and industries. This can avoid the need for users to buy new drones or switch to new drone platforms if they are already using some types of drones that do not include mapping capabilities. The mapping and control system can be used on different drone platforms to meet mission/application specific requirements.

In one example, the system can be configured and calibrated using a substantially automated process, so that the system can be setup without requiring detailed knowledge and in a short space of time.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means ±20%.

Persons skilled in the art will appreciate that numerous variations and modifications will become apparent. All such variations and modifications which become apparent to persons skilled in the art, should be considered to fall within the spirit and scope that the invention broadly appearing before described.

1. A mapping and control system for an aerial vehicle, the system including a payload attachable to the aerial vehicle, the payload including:
a) a range sensor that generates range data indicative of a range to an environment;
b) a memory for storing flight plan data indicative of a desired flight plan;
c) a communications interface; and,
d) one or more processing devices that:
i) use the range data to generate pose data indicative of a position and orientation of the payload relative to the environment;
ii) use the pose data and the flight plan data to identify manoeuvres that can be used to execute the flight plan;
iii) generate control instructions in accordance with the manoeuvres; and,
iv) transfer the control instructions to a vehicle control system of the aerial vehicle via the communications interface, to cause the aerial vehicle to implement the manoeuvres and thereby fly autonomously in accordance with the desired flight plan, and wherein the range data is further for use in generating a map of the environment.

2. The mapping and control system of claim 1, wherein the system includes at least one of:
a) a movement sensor that generates payload movement data indicative of a payload movement;
b) an orientation sensor that generates payload orientation data indicative of a payload orientation;
c) an inertial measurement unit that generates at least one of payload movement data and payload orientation data; and,
d) a position sensor that generates payload position data indicative of a payload position.

3. The mapping and control system of claim 2, wherein the one or more processing devices identify the manoeuvres using pose data and at least one of:
a) payload orientation data;
b) payload movement data; and,
c) payload position data.

4. The mapping and control system according to of claim 2, wherein the one or more processing devices modify pose data using at least one of:
a) payload orientation data;
b) payload movement data; and,
c) payload position data.

5. The mapping and control system of claim 1, wherein the one or more processing devices:
a) use the range data and pose data to generate a depth map indicative of a minimum range to the environment in a plurality of directions; and,
b) identify the manoeuvres in accordance with the depth map to thereby perform collision avoidance.

6. The mapping and control system of claim 1, wherein the one or more processing devices perform collision avoidance in accordance with at least one of:
a) an extent to the vehicle; and,
b) an exclusion volume surrounding an extent of the vehicle.

7. The mapping and control system of claim 6, wherein the one or more processing devices determine the extent of the vehicle using at least one of:
a) configuration data;
b) calibration data; and,
c) the range data.

8. The mapping and control system of claim 1, wherein the one or more processing devices:
a) use the range data and pose data to generate an occupancy grid indicative of a presence of the environment in different voxels of a grid; and,
b) identify the manoeuvres using the occupancy grid.

9. The mapping and control system of claim 1, wherein the one or more processing devices at least one of identify manoeuvres and generate control instructions using configuration data indicative of characteristics of the vehicle and vehicle control system.

10. The mapping and control system of claim 9, wherein the one or more processing devices retrieve the configuration data from a data store based on at least one of:
a) a vehicle type; and,
b) a vehicle control system type.

11. The mapping and control system of claim 1, wherein the one or more processing devices determine at least one of manoeuvres and control instructions using calibration data indicative of at least one of:
a) a relative position and orientation of the payload and the vehicle; and,
b) an overall weight.

12. The mapping and control system of claim 1, wherein the one or more processing devices perform calibration by:
a) comparing vehicle orientation data obtained from a vehicle orientation sensor to payload orientation data to determine a relative orientation of the vehicle and payload;
b) comparing vehicle movement data obtained from a vehicle movement sensor to payload movement data to determine a relative position of the vehicle and payload; and,
c) generating calibration data indicative of the relative position and orientation of the payload and vehicle.

13. The mapping and control system of claim 12, wherein the one or more processing devices acquire the vehicle orientation data and vehicle movement data from vehicle sensors via the communications module.

14. The mapping and control system of claim 12, wherein the one or more processing devices determine at least one of the payload orientation data and payload movement data at least in part using the pose data.

15. The mapping and control system of claim 12, wherein the one or more processing devices acquire the vehicle orientation data and the payload orientation data at least one of:
a) while the vehicle is static; and,
b) synchronously.

16. The mapping and control system of claim 12, wherein the one or more processing devices synchronously acquire the vehicle movement data and the payload movement data during movement of the vehicle.

17. The mapping and control system of claim 16, wherein the set movement of the vehicle is performed at least one of:
a) by manually moving the vehicle; and,
b) by causing the vehicle to fly a sequence of predetermined manoeuvres.

18. The mapping and control system of claim 1, wherein the one or more processing devices generate calibration data by comparing a measured vehicle response to an expected vehicle response associated with a control instruction.

19. The mapping and control system of claim 1, wherein the one or more processing devices determine at least one of a vehicle type and a vehicle control system type by at least one of:
a) querying the vehicle control system; and,
b) in accordance with user input commands.

20. The mapping and control system of claim 1, wherein the one or more processing devices determine a data quality by at least one of:
a) analysing at least one of:
i) range data; and,
ii) a point cloud derived from the range data; and,
b) comparing movement determined from the pose data to movement data measured using a movement sensor.

21. The mapping and control system of claim 1, wherein the one or more processing devices determine the flight plan using at least one of:
a) configuration data;
b) an environment map generated using the range data;
c) a vehicle control system status;
d) a vehicle status;
e) a data quality; and,
f) a mission status.

22. The mapping and control system of claim 1, wherein the one or more processing devices determine the flight plan at least in part using flight plan data stored in memory, wherein the flight plan data defines at least one of:
a) a mapping flight plan;
b) an abort flight plan; and,
c) a return to home flight plan.

23. The mapping and control system of claim 1, wherein the one or more processing devices determine a vehicle control system status by at least one of:
a) querying the vehicle control system;
b) attempting to communicate with the vehicle control system; and,
c) comparing a measured vehicle response to an expected vehicle response associated with a control instruction, the measured vehicle response being determined using at least one of:
i) pose data;
ii) movement data; and,
iii) orientation data.

24. The mapping and control system of claim 1, wherein the one or more processing devices determine the vehicle status by at least one of:
a) querying the vehicle control system; and,
b) comparing a measured vehicle response to an expected vehicle response associated with a control instruction, the measured vehicle response being determined using at least one of:
i) pose data;
ii) movement data; and,
iii) orientation data.

25. The mapping and control system of claim 1, wherein the control instructions are indicative of at least one of:
a) a waypoint;
b) a set altitude;
c) a set velocity;
d) a set attitude and thrust; and,
e) motor control settings.

26. The mapping and control system of claim 1, wherein the one or more processing devices communicate with the vehicle control system via an API.

27. The mapping and control system according to any one of the claim 1, wherein the payload includes a mounting to attach the payload to the vehicle.

28. The mapping and control system of claim 1, wherein the range sensor is configured to operate in first and second orientations, wherein in the first orientation the range sensor is positioned under the payload and in the second orientation the range sensor is positioned laterally relative to the payload.

29. The mapping and control system of claim 1, wherein the range sensor is a Lidar sensor.

30. A method of performing mapping and controlling an aerial vehicle using a payload attachable to the aerial vehicle, the payload including:
a) a range sensor that generates range data indicative of a range to an environment;
b) a memory for storing flight plan data indicative of a desired flight plan;
c) a communications interface; and,
d) one or more processing devices, wherein the method includes, in the one or more processing devices:
i) using the range data to generate pose data indicative of a position and orientation of the payload relative to the environment;
ii) using the pose data and the flight plan data to identify manoeuvres that can be used to execute the flight plan;
iii) generating control instructions in accordance with the manoeuvres; and,
iv) transferring the control instructions to a vehicle control system of the aerial vehicle via the communications interface, to cause the aerial vehicle to implement the manoeuvres and thereby fly autonomously in accordance with the desired flight plan, and wherein the range data is further for use in generating a map of the environment.

31. A method of calibrating a mapping and control system for an aerial vehicle, the system including a payload attachable to the aerial vehicle, the payload including:
a) a range sensor that generates range data indicative of a range to an environment, the range data being usable in generating a map of the environment;
b) a memory for storing flight plan data indicative of a desired flight plan for mapping the environment;
c) a communications interface; and,
d) one or more processing devices, wherein the method includes, in the one or more processing devices:
i) acquiring from vehicle sensors, via the communications module:
(1) vehicle orientation data indicative of a vehicle orientation; and,
(2) vehicle movement data indicative of vehicle movement;
ii) acquiring:
(1) payload orientation data indicative of a payload orientation; and,
(2) payload movement data indicative a payload movement;
iii) comparing the vehicle orientation data and payload orientation data to determine a relative orientation of the vehicle and payload;
iv) comparing the vehicle movement data and payload movement data to determine a relative position of the vehicle and payload; and,
v) generating calibration data indicative of the relative position and orientation of the payload and vehicle, wherein the calibration data is used in at least one of mapping and controlling the aerial vehicle.

32. The method of claim 31, wherein the method includes:
a) using the range data to generate pose data indicative of a position and orientation of the payload relative to the environment; and,
b) determining at least one of the payload orientation data and payload movement data at least in part using the pose data.

33. The method of claim 31, wherein the method includes determining at least one of the payload orientation data and payload movement data using at least one of:
a) a position sensor;
b) a movement sensor;
c) an orientation sensor; and,
d) an inertial measurement unit.

34. The method of claim 31, wherein the method includes acquiring the vehicle orientation data and the payload orientation data at least one of:
a) while the vehicle is static; and,
b) synchronously.

35. The of claim 31, wherein the method includes synchronously acquiring the vehicle movement data and the payload movement data during movement of the vehicle.

36. The method of claim 35, wherein movement of the vehicle is performed at least one of:
a) by manually moving the vehicle; and,
b) by causing the vehicle to fly at least one predetermined manoeuvres.

37. The method of claim 31, wherein the one or more processing devices generate calibration data by comparing a measured vehicle response to an expected vehicle response associated with a control instruction.

38. The method of claim 31, wherein the method is performed using the mapping and control system of claim 1.
